(19) United States
(12) Patent Application Publication
(10) Pub. No.: US 2008/0094315 A1
(43) Pub. Date: Apr. 24, 2008

(54) Method

(75) Inventors: Mark Thomas Johnson, Eindhoven (NL); Guofu Zhou, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/572,573

(22) PCT Filed: Jul. 20, 2005
(86) PCT No.: PCT/IB05/52424

§ 371 Date: Jan. 24, 2007

(30) Foreign Application Priority Data
Jul. 27, 2004 (EP) 04103582.5

(51) Int. Cl. G09G 3/34; G09G 3/20

(52) U.S. Cl. 345/58; 345/107

(57) ABSTRACT

A driver (15, 10, 16) for an electrophoretic display (1) comprising pixels (18), comprises a controller (15) to select a particular drive waveform (Dij) for a particular one of the pixels (18) out of a particular set of drive waveforms (Si) being selected out of a plurality of sets of waveforms (So, . . . , Si). A selection of the particular set of drive waveforms (Si) out of the plurality of sets of waveforms (So, . . . , Si) is determined dependent on optical states of adjacent pixels (18) being adjacent to the particular one of the pixels (18) such that the crosstalk between the adjacent pixels (18) and the particular one of the pixels (18) is decreased. Each set of drive waveforms (Si) comprises drive waveforms (Dij) required to obtain optical states of the particular one of the pixels (18) suitable for a particular configuration of the optical states of the adjacent pixels (18). A selection of the particular drive waveform (Dij) from the particular set of drive waveforms (Di) is determined by a desired optical state of the particular one of the pixels (18). A pixel driver (10, 16) supplies the drive waveforms to the pixels (18).

The invention relates to a driver for an electrophoretic display, a display panel comprising such a driver, a display apparatus comprising such a display panel, and a method of driving an electrophoretic display.

A display device of the type mentioned in the opening paragraph is known from the international patent application WO 99/53373. This patent application discloses an electronic ink display (further also referred to as E-ink display) which comprises two substrates. One substrate is transparent, the other substrate is provided with electrodes arranged in rows and columns. Display elements or pixels are associated with intersections of the row and column electrodes. Each display element is coupled to the column electrode via a main electrode of a thin-film transistor (further also referred to as TFT). A gate of the TFT is coupled to the row electrode. This arrangement of display elements, TFT's and row and column electrodes jointly forms an active matrix display device.

Each pixel comprises a pixel electrode which is the electrode of the pixel which is connected via the TFT to the column electrodes. During an image update or image refresh period, a row driver is controlled to select all the rows of display elements one by one, and the column driver is controlled to supply data signals in parallel to the selected row of display elements via the column electrodes and the TFT's. The data signals correspond to image data to be displayed on the matrix display device.

Furthermore, an electronic ink is provided between the pixel electrode and a common electrode provided on the transparent substrate. The electronic ink is thus sandwiched between the common electrode and the pixel electrodes. The electronic ink comprises multiple microcapsules of about 10 to 50 microns. Each microcapsule comprises positively charged white particles and negatively charged black particles suspended in a fluid. When a positive voltage is applied to the pixel electrode, the white particles move to the side of the microcapsule directed to the transparent substrate, and the display element appears white to a viewer. Simultaneously, the black particles move to the pixel electrode at the opposite side of the microcapsule where they are hidden from the viewer. By applying a negative voltage to the pixel electrode, the black particles move to the common electrode at the side of the microcapsule directed to the transparent substrate, and the display element appears dark to a viewer. When the electric field is removed, the display device remains in the acquired state and exhibits a bi-stable character. This electronic ink display with its black and white particles is particularly useful as an electronic book.

Grey scales can be created in the display device by controlling the amount of particles that move to the common electrode at the top of the microcapsules. For example, the energy of the positive or negative electric field, defined as the product of field strength and time of application, controls the amount of particles moving to the top of the microcapsules.

A disadvantage of the known display device is that it may suffer from cross-talk between the pixels.

It is an object of the invention to decrease the cross-talk between the pixels of an electrophoretic display.

A first aspect of the invention provides a driver for an electrophoretic display as claimed in claim 1. A second aspect of the invention provides a display panel as claimed in claim 10. A third aspect of the invention provides a display apparatus as claimed in claim 11. A fourth aspect of the invention provides a method of driving as claimed in claim 12. Advantageous embodiments are defined in the dependent claims.

In the prior art E-Ink display, which is an electrophoretic display, the cross-talk may become particularly relevant if an increased response speed of the electrophoretic display is required and the voltage difference across the electrophoretic particles is maximized. In displays based on electrophoretic particles in films comprising either capsules or compartments such as micro-cups, additional layers such as adhesive layers and binder layers are required for the construction. These layers are also situated between the electrodes, they usually cause voltage drops and hence reduce the voltage across the particles. To increase the response speed it is therefore possible to increase the conductivity of these layers. However, this may cause cross-talk in an electrophoretic display, because a portion of the electric field associated with a particular pixel is inadvertently spread to neighboring pixels. This portion of the electric field changes the optical state of these pixels to deviate from the intended optical state. This is extremely visible if a pixel which is driven to one of the extreme optical states is situated adjacent to a pixel that is not driven. Such a situation is frequently encountered if additional grey levels are achieved with spatial dithering techniques using checker-board like patterns wherein black and white pixels alternate.

The driver for an electrophoretic display in accordance with the first aspect of the invention comprises a controller which selects a particular drive waveform for a particular pixel out of a particular set of drive waveforms. This particular set of drive waveforms is selected out of a plurality of sets of waveforms. The selection of the particular set of drive waveforms out of the plurality of sets of waveforms is dependent on optical states of pixels which are adjacent to the particular pixel. The selection is such that the cross-talk between the adjacent pixels and the particular pixel is decreased. Each set of drive waveforms comprises drive waveforms required to obtain optical states of the particular pixel suitable for a particular configuration of the optical states of the adjacent pixels. The required drive waveforms may be found experimentally for the different possible configurations of the optical states of the adjacent pixels. The selection of the particular drive waveform from the particular set of drive waveforms is determined by a desired optical state of the particular one of the pixels. A pixel driver supplies the drive waveforms to the pixels.

Thus, the cross-talk is decreased by modify the driving of the pixels by increasing the number of sets of driving waveforms. Now also sets are included which comprise the (image update) drive waveforms taking different configurations of the optical states of the adjacent pixels into account. The optimal drive waveform for the particular pixel which is surrounded by the adjacent pixels is selected based on the detected configuration.

In an embodiment as claimed in claim 2, the pixel driver comprises a memory to store the previous image, and a comparator to compare a present image with the stored previous image to determine desired optical transitions to be made by the pixels. Now, the optical states are optical transitions. This approach is in particular relevant if the optical state of the pixels depends on the optical transition to be made such as in E-Ink electrophoretic displays.

In an embodiment as claimed in claim 3, each set of drive waveforms comprises all the drive waveforms which are required to cover all possible optical transitions a pixel can make. For example, if the pixels have four optical states, sixteen possible optical transitions exist and thus the set of drive waveforms may comprise sixteen different drive waveforms. The set of drive waveforms may comprise less than sixteen different waveforms if identical waveforms can be used for different optical transitions. The four optical states may be, for example, white, light grey, dark grey and black.

In an embodiment as claimed in claim 4, the desired optical transitions are stored in a memory. In known E-Ink based electrophoretic displays, the result of the comparison of the previous and the new optical state of the pixels leads directly to the drive waveform required. Thus a simple and quick calculation uniquely defined by the initial and final optical state of the pixel is carried out repeatedly as every line of information is addressed, and the correct waveform is selected just before the pixel is driven. Defining the correct drive waveform in the present invention may be considerable more complicated, because it depends on the number of waveform sets and the criteria used to select the correct set of waveforms. As the calculation may be time-consuming, in a preferred embodiment, the controller stores the outcome of the comparison in a memory. Now, the comparison needs only to be performed once, before the start of the image update. The data stored in the memory is retrieved during the addressing of the line of information to select the correct drive waveform.

In an embodiment as claimed in claim 5, the drive waveforms of the extra sets of drive waveforms differ from the drive waveforms of the already present set of drive waveforms in that the data portion or driving pulse is adapted. The already present set of drive waveforms is the set of drive waveforms which is required if the cross-talk is not counteracted. The relative timing (temporal position) of the data portion may be different in different waveforms of the same set. This covers the option that an identical pulse is intentionally delayed in time but does not change level or magnitude. Such a delayed pulse can also be used to counteract the crosstalk.

In an embodiment as claimed in claim 6, the particular drive waveform further comprises a reset pulse.

In an embodiment as claimed in claim 7, the particular drive waveform comprises a reset pulse which has duration and/or level dependent on the optical states of adjacent pixels.

In an embodiment as claimed in claim 8, the particular drive waveform further comprises a shaking pulse.

In an embodiment as claimed in claim 9, the drive waveforms may comprise a first shaking pulse, a reset pulse, a second shaking pulse, and a driving pulse.

From the patent applications in accordance to applicants docket referred to as PHNL020441 and PHNL030091, which have been filed as European patent applications 02077017.8 and 03100133.2, it is known to minimize the image retention by using pre-pulses also referred to as shaking pulses. Preferably, the shaking pulses comprise a series of AC-pulse, however, the shaking pulses may comprise a single pulse only. The patent applications are directed to the use of shaking pulses, either directly before the drive pulses, or directly before the reset pulse, or both.

These and other aspects of the invention are apparent from and will be elucidated with reference to the embodiments described hereinafter.

In the drawings:

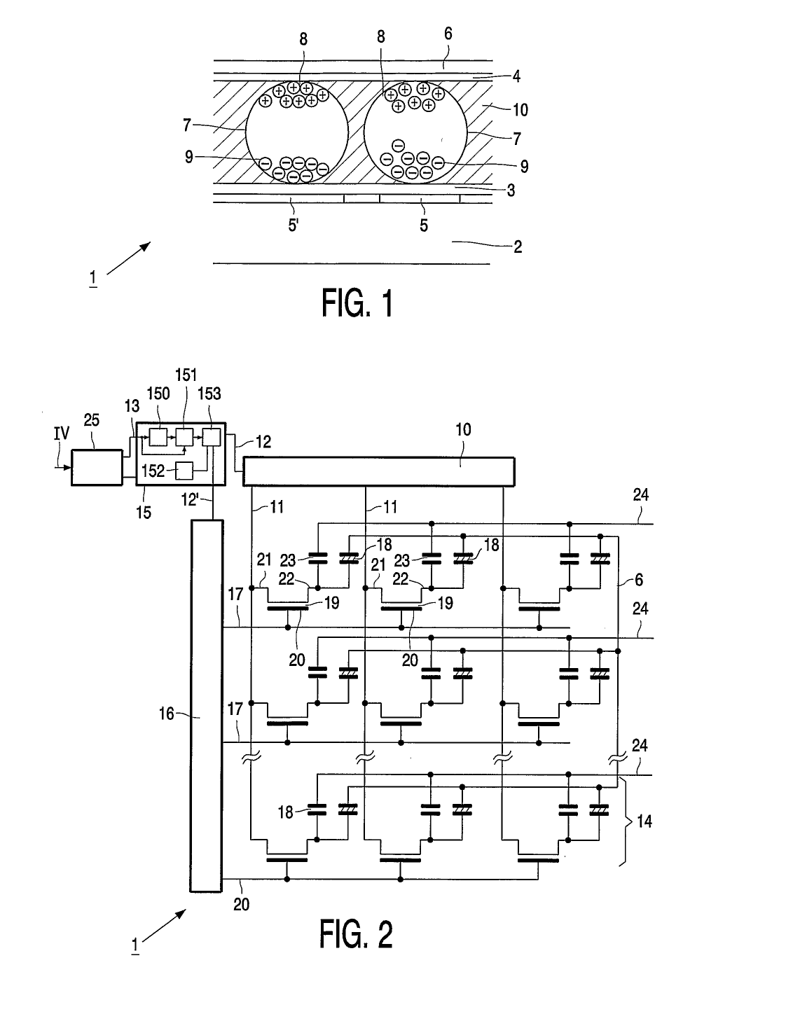

FIG. 1 shows diagrammatically a cross-section of a portion of an electrophoretic display device,

FIG. 2 shows diagrammatically a display apparatus with an equivalent circuit diagram of a portion of the electrophoretic display device, and

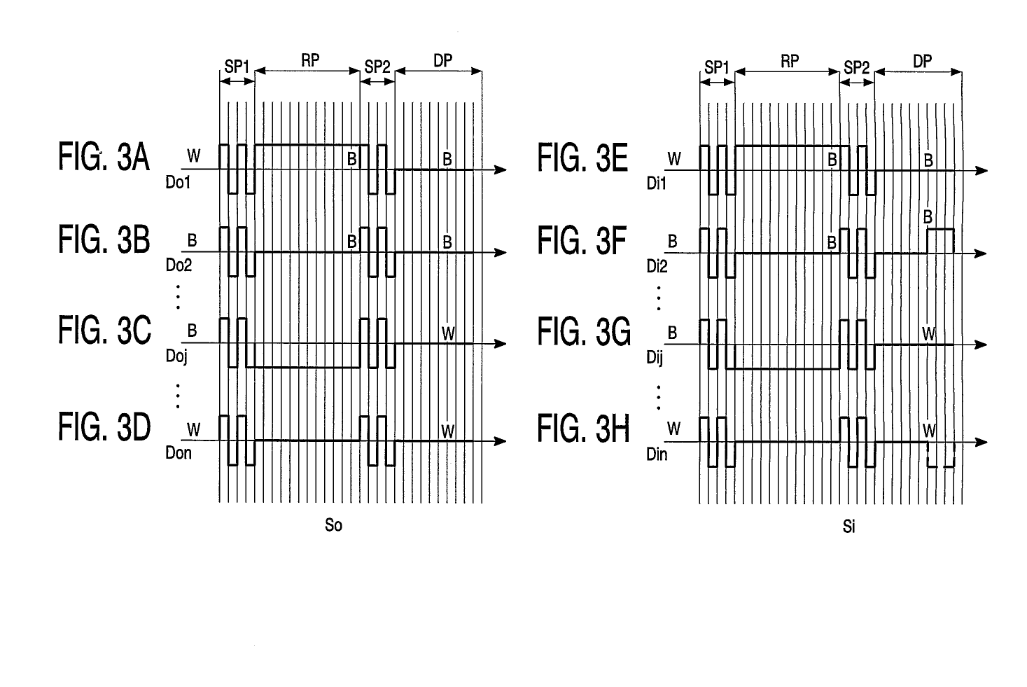

FIGS. 3A-3H show drive waveforms with and without crosstalk compensation.

FIG. 1 diagrammatically shows a cross-section of a portion of an electrophoretic display device 1 which for example has the size of a few display elements. The electrophoretic display device 1 comprises a base substrate 2, an electrophoretic film with an electronic ink which is present between two transparent substrates 3 and 4 which, for example, are of polyethylene. One of the substrates 3 is provided with transparent picture electrodes 5, 5′ and the other substrate 4 with a transparent counter electrode 6. The electronic ink comprises multiple micro capsules 7, of about 10 to 50 microns. The microcapsules 7 need not be ball-shaped, any other shape, such as for example, predominantly rectangular, is possible. Each micro capsule 7 comprises positively charged black particles 8 and negative charged white particles 9 suspended in a fluid 40. The dashed material 41 is a polymeric binder. The particles 8 and 9 may have other colors than black and white. It is only important that the two types of particles 8, 9 have different optical properties and different charges such that they act differently to an applied electric field. The layer 3 is not necessary, or could be a glue layer. When a negative voltage is applied to the counter electrode 6 with respect to the picture electrodes 5, an electric field is generated which moves the black particles 8 to the side of the micro capsule 7 directed to the counter electrode 6 and the display element will appear dark to a viewer. Simultaneously, the white particles 9 move to the opposite side of the microcapsule 7 where they are hidden to the viewer. By applying a positive field between the counter electrodes 6 and the picture electrodes 5, the white particles 9 move to the side of the micro capsule 7 directed to the counter electrode 6 and the display element will appear white to a viewer (not shown). When the electric field is removed the particles 7 remain in the acquired state and the display exhibits a bi-stable character and consumes substantially no power.

FIG. 2 shows diagrammaticaly an equivalent circuit of a picture display device 1 comprising an electrophoretic film laminated on the base substrate 2 provided with active switching elements 19, a row driver 16 and a column driver 10. Preferably, the counter electrode 6 is provided on the film comprising the encapsulated electrophoretic ink, but, the counter electrode 6 could be alternatively provided on a base substrate if a display operates based on using in-plane electric fields. The display device 1 is driven by active switching elements, which, for example, are thin film transistors 19. The display device 1 comprises a matrix of display elements at the area of intersecting row or selection electrodes 17 and column or data electrodes 11. The row driver 16 consecutively selects the row electrodes 17, while a column driver 10 provides data signals to the column electrodes 11 for the selected row electrode 17. Preferably, a processor 15 firstly processes incoming data 13 into the data signals to be supplied by the column electrodes 11.

The control lines 12 and 12′ carry signals which control the mutual synchronisation between the column driver 10 and the row driver 16. Select signals from the row driver 16 which are electrically connected to the row electrodes 17 select the pixel electrodes 22 via the gate electrodes 20 of the thin film transistors 19. The source electrodes 21 of the thin film transistors 19 are electrically connected to the column electrodes 11. A data signal present at the column electrode 11 is transferred to the pixel electrode 22 of the display element 18 (also referred to as pixel) coupled to the drain electrode of the TFT. In the embodiment shown, the display device of FIG. I further comprises an optional capacitor 23 at the location of each display element 18. This optional capacitor 23 is connected between the pixel electrodes 22 of the associated pixel 18 and one or more storage capacitor lines 24. Instead of a TFT other switching elements can be applied such as diodes, MIM's, etc.

The processor 15 may comprise a memory 150 a comparator 151 a controller 153 and a memory 152. The memory 150 stores a previous image of the incoming data 13. The comparator 151 compares a present image of the incoming data 13 with the stored previous image to determine desired optical transitions to be made by the pixels 18. The controller 153 checks for each pixel 18 what the optical transitions are of the adjacent pixels 18. The adjacent pixels 18 may be all or a sub-set of the pixels 18 immediately surrounding the particular pixel 18. For example, the adjacent pixels 18 may be the adjacent pixels in the same row, or both the adjacent pixels 18 in the same row (17) and the same column (11) or adjacent pixels at the comers of the particular pixel. Depending on the optical transition to be made by the particular pixel 18, the suitable drive waveform Dij for the particular pixel 18 is selected from a set Si of drive waveforms Dij which belongs to the determined pattern of optical transitions of the adjacent pixels 18. Thus, different sets Si of drive waveforms Dij may be used for different patterns of optical transitions of the adjacent pixels 18. Each of these sets Si comprises all the waveforms required to obtain all the possible optical transitions of the particular pixel 18 taking care of the pattern of optical transitions of the adjacent pixels 18 such that the crosstalk effects on the particular pixel 18 due to the optical transitions of the adjacent pixels 18 are decreased or compensated. This will be elucidated with an example shown in FIGS. 3. The different drive waveforms Dij or references thereto may be stored in the memory 152. If all the required drive waveforms Dij are stored in the memory, the controller 153 can simply retrieve the appropriate drive waveform Dij fitting the required optical transition of the particular pixel 18 for the present pattern of optical transitions of the adjacent pixels 18. Otherwise, the controller 153 uses the reference to the drive waveform to generate the correct drive waveform Di.

In a display apparatus which comprises the display panel 1, an image processing circuit 25 is present which receives the input data signal IV to supply images as the incoming data 13 to the processor 15. The incoming data 13 determines the optical transitions to be made be the pixels 18.

FIGS. 3A-3H show drive waveforms with and without crosstalk compensation. On the left hand, FIGS. 3A to 3D show an example of standard drive waveforms which are used when no compensation for the optical transitions of adjacent pixels 18 as performed, or if such a compensation is not required, for example when all adjacent pixels have the same optical transition as the central pixel.

The known drive of electrophoretic displays only uses the single set So of drive waveforms which for each optical transition to be made by the particular pixel 18 comprises the same drive waveform Doj. In the example shown in FIGS. 3A to 3D only four of n drive waveforms Do1 to Don (collectively also referred to as Doj) for only four of the n optical transitions are shown. The shown drive waveforms are respectively: Do1 for the optical transition from white W to black B, Do2 for the optical transition from black B to black B, Doj for the optical transition from black B to white W, and Don for the optical transition from white W to white W.

The known drive waveforms are only briefly elucidated because a detailed description is well known, for example from the already mentioned European patent applications. In all the drive waveforms Do1 to Don, the shaking pulses SP1 comprise a series of pulses having alternating polarity which are time aligned. Also the shaking pulses SP2 are present in all the drive waveforms Do1 to Don and are time aligned. However, the shaking pulses SP1 and/or SP2 need not be time aligned. Further, the shaking pulses SP1, SP2 need not be present if no change of level is required. In the waveform Do1, the reset pulse RP has the positive polarity such that all the positive black particles 9 are moved to the top of the micro capsules 7 and the pixel 18 appears black, no driving pulse DP is required to reach the desired optical state black B. In the waveform Do2, no optical transition is required and thus no reset is required, although a positive polarity reset pulse may be applied, preferably with a short duration and/or low amplitude to prevent sticking of the particles 8 and 9. In the waveform Doj, the reset pulse RP has a negative polarity to move all the negative white particles to the top of the micro capsules 7 and the pixel 18 appears white, no driving pulse DP is required anymore to reach the desired optical state white W. In the waveform Don, no optical transition is required and thus no reset is required, although a negative polarity reset pulse may be applied. If intermediate grey levels have to be displayed, a non-zero drive pulse DP is required to change the optical state of the pixel 18 from either the well defined white or black state reached by applying the reset pulse RP.

If the particles have other colors, other optical transitions will occur. Further optical states may be present, such as light grey and dark grey. If the optical states black B, dark grey, light grey, and white W are possible, 16 possible optical transitions exist, each which a corresponding drive waveform Do1 to Don, with n=16. Not all these waveforms must be different. This known approach does not take care of the crosstalk introduced by optical transitions of pixels 18 adjacent to the particular pixel 18. The set So of drive waveforms Doj is also referred to as the standard set of drive waveforms.

By way of example only, the standard waveforms Doj shown in FIGS. 3A to 3D comprise in the order shown: first shaking pulses SP1, reset pulses RP, second shaking pulses SP2, and driving pulses DP. For the four optical transitions shown, the driving pulses DP have zero amplitude. The shaking pulses SP1 and SP2 decrease the inertness of the particles 8 and 9 such that they have a faster response to the reset pulses RP and the driving pulses DP. The reset pulses RP improve the reproducibility of the optical states of the pixels 18 by first changing the optical states of the pixels 18 to a well defined limit state (black B, or white W). However, both or one of the shaking pulses SP1, SP2, and/or the reset pulse RP need not be present.

For each possible pattern of optical transitions of the adjacent pixels 18, it is possible to determine what the effect of the crosstalk is on the particular pixel 18. The standard waveforms can then be adapted to cater for this crosstalk such that the crosstalk decreases or is compensated. One set Si of adapted drive waveforms Dij is shown in FIGS. 3E to 3H. This set of drive waveforms Dij is required if the (sum of the) crosstalk of the optical transitions of the adjacent pixels 18 on the particular pixel 18 cause a shift of the optical state of the particular pixel 18 towards white. This white-shift occurs if a majority of the adjacent pixels 18 have an optical transition from black to white. For an optical transition from black to white, a negative reset and/or drive voltage is required. Due to the crosstalk part of this negative voltage will be applied to the particular pixel 18 and thus will cause the white shift.

FIG. 3E shows the drive waveform Di1 required to obtain an optical transition from white W to black B. This drive waveform Di1 is identical to the drive waveform Do1 of FIG. 3A. Due to the reset pulse RP, which overrides the crosstalk components caused by reset pulses RP of adjacent pixels 18, the particular pixel 18 is reset to black B.

FIG. 3F shows the drive waveform Di2 which is based on the drive waveform Do2. Due to the crosstalk, in this example caused by the negative reset pulse RP of an adjacent pixel 18, and the absence of a reset pulse RP for the particular pixel 18, the white shift occurs. This white shift is compensated by the positive drive pulse DP. The drive pulse DP of the adapted drive waveform Di2 may coincide completely or partly in position (time of occurrence in the drive waveform) with the drive pulse DP of the standard drive waveforms for optical transitions to grey levels in-between black B and white W (not shown). The drive pulse DP of the adapted drive waveform Di2 may also precede or succeed the position of drive pulse DP of the standard drive waveforms. Instead of adapting or adding a drive pulse DP, it is also possible to adapt the amplitude and/or duration of the reset pulse such that the effect of the crosstalk is decreased.

FIG. 3G shows the drive waveform Dij required to obtain an optical transition from black B to white W. This drive waveform Dij is identical to the drive waveform Doj of FIG. 3C. Due to the reset pulse RP, which overrides the crosstalk components caused by reset pulses RP of adjacent pixels 18, the particular pixel 18 is reset to white W. Anyhow, the crosstalk could only cause a shift towards white, but whiter than white is not possible.

FIG. 3H shows the drive waveform Din which is based on the drive waveform Don. Due to the crosstalk, in this example caused by a negative reset pulse RP of an adjacent pixel 18, and the absence of a reset pulse RP for the particular pixel 18, the white shift occurs. This white shift need not be compensated because whiter than white is not possible.

However, it is also possible that a black shift occurs. This black-shift occurs if a majority of the adjacent pixels 18 have an optical transition from white to black. For an optical transition from white to black, a positive reset and/or drive voltage is required. Due to the crosstalk, part of this positive voltage will be applied to the particular pixel 18 and thus will cause its black shift. If the adjacent pixels have optical transitions such that a black shift is introduced into the particular pixel, this black shift can be compensated by introducing a positive drive pulse DP (indicated by the dashed pulse) in the waveform Din. This later waveform belongs to another set of waveforms because the configuration of the optical transitions of the adjacent pixels is different.

Thus, the crosstalk is decreased by using several sets So to Si of drive waveforms Dij instead of a single set So of drive waveforms Doj. Dependent on the configuration of the optical transitions of the adjacent pixels 18, a particular crosstalk will result in the particular pixel 18. This crosstalk is decreased by selecting a drive waveform for the optical transition desired for the particular pixel from a set of waveforms which fits the actual configuration of the optical transitions of the adjacent pixels 18.

To conclude, the operation of the electrophoretic display in accordance with the present invention may be as follows:

(i) as in the prior art electrophoretic display, the image content of the present image and the new image are stored in a memory of the control electronics.

(ii) the content of the two images is compared, whereby not only the initial and the final state of a particular pixel 18 is determined (as in the prior art) but also the nature of the surroundings of the particular pixel 18. In general, the pixel surroundings of the new image will be most important for determining the effect of the crosstalk.

(iii) When the comparison is made, the control electronics will invoke one of a series of drive waveforms Dij to switch the particular pixel 18 from the previous optical state to the new optical state. The waveform selected depends on the optical states (especially in the new picture) or the optical transitions of the surrounding pixels 18 which surround the particular pixel 18. Usually, also the initial state of the particular pixel 18 has to be known to select the correct waveform.

In an example of a display with 4 grey levels, each set Si of drive waveforms Dij may comprise sixteen different drive waveforms Dij to cover all possible transitions from one grey level to another. For example, different sets Si may be created for any of the following cases. The adjacent pixels 18 of the particular pixel 18 all have the same optical transition. At least one of the adjacent pixels 18 has a different optical transition than the particular pixel 18. The majority of the adjacent pixels 18 have a different optical transition than the particular pixel 18. All the adjacent pixels 18 have a different optical transition than the particular pixel 18. Further, the sets Si may be extended to include different sets dependent on the polarity of the optical transitions of the adjacent pixels, the position of the adjacent pixels 18 which have a different optical transition than the particular pixel 18, or whether the particular pixel 18 is at an edge of the display.

It should be noted that the above-mentioned embodiments illustrate rather than limit the invention, and that those skilled in the art will be able to design many alternative embodiments without departing from the scope of the appended claims. It is not essential to the invention that the electrophoretic display is an E-ink display. The invention is useful for any other electrophoretic display in which particles move due to an applied electric field.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A driver (15, 10, 16) for an electrophoretic display (1) comprising pixels (18), the driver (15, 10, 16) comprises
a controller (15) for selecting a particular drive waveform (Dij) for a particular one of the pixels (18) out of a particular set of drive waveforms (Si) being selected out of a plurality of sets of waveforms (So, . . . , Si), a selection of the particular set of drive waveforms (Si) out of the plurality of sets of waveforms (So, . . . , Si) being determined dependent on optical states of adjacent pixels (18) being adjacent to the particular one of the pixels (18) to decrease a cross-talk between the adjacent pixels (18) and the particular one of the pixels (18) , each set of drive waveforms (Si) comprising drive waveforms (Dij) required to obtain optical states of the particular one of the pixels (18) suitable for a particular configuration of the optical states of the adjacent pixels (18), a selection of the particular drive waveform (Dij) from the particular set of drive waveforms (Di) being determined by a desired optical state of the particular one of the pixels (18), and
a pixel driver (10, 16) for supplying the drive waveforms to the pixels (18).

2. A driver (15, 10, 16) as claimed in claim 1, further comprising
a memory (150) for storing a previous image,
a comparator (151) for comparing a present image with the previous image to determine desired optical transitions to be made by the pixels (18), and wherein the optical states are optical transitions.

3. A driver (15, 10, 16) as claimed in claim 1, wherein each set of drive waveforms (Di) comprises the drive waveforms (Dij) required to cover all possible optical transitions.

4. A driver (15, 10, 16) as claimed in claim 2, further comprising a further memory (152) for storing references to waveforms (Dij) required to obtain the desired optical transitions.

5. A driver (15, 10, 16) as claimed in claim 1, wherein the pixel driver (10, 16) is arranged for supplying the particular drive waveform (Dij) comprising a data portion (DP) having a different duration and/or level and/or relative timing dependent on the optical states of the adjacent pixels (18).

6. A driver (15, 10, 16) as claimed in claim 5, wherein the pixel driver (10, 16) is arranged for supplying the particular drive waveform (Dij) comprising a reset pulse (RP).

7. A driver (15, 10, 16) as claimed in claim 1, wherein the pixel driver (10, 16) is arranged for supplying the particular drive waveform (Dij) comprising a reset pulse (RP) having a different duration and/or level and/or relative timing dependent on the optical states of adjacent pixels (18).

8. A driver (15, 10, 16) as claimed in any one of the claims 5, 6, or 7, wherein the pixel driver (10, 16) is arranged for supplying the particular drive waveform (Dij) further comprising a shaking pulse (SP1; SP2).

9. A driver (15, 10, 16) as claimed in claim 6, wherein the pixel driver (10, 16) is arranged for supplying the drive waveforms (Dij) comprising successively, a first shaking pulse (SP1), the reset pulse (RP), a second shaking pulse (SP2), and a driving pulse being the data portion (DP).

10. A display panel comprising an electrophoretic display (1) and the driver (15, 10, 16) as claimed in claim 1.

11. A display apparatus comprising the display panel as claimed in claim 10, and an image processing circuit (25) for receiving input data (IV) to supply images (13) to the driver (15, 10, 16) determining the optical transitions.

12. A method of driving an electrophoretic display comprising pixels (18), the method comprises
selecting (15) a particular drive waveform (Dij) for a particular one of the pixels (18) out of a particular set of drive waveforms (Si) being selected out of a plurality of sets of waveforms (So, . . . , Si), a selection of the particular set of drive waveforms (Si) out of the plurality of sets of waveforms (So, . . . , Si) being dependent on optical states of adjacent pixels (18) being adjacent to the particular one of the pixels (18) to decrease a cross-talk between the adjacent pixels (18) and the particular one of the pixels (18), each set of drive waveforms (Si) comprising drive waveforms (Dij) required to obtain optical states of the particular one of the pixels (18) suitable for a particular configuration of the optical states of the adjacent pixels (18), a selection of the particular drive waveform (Dij) from the particular set of drive waveforms (Si) being determined by a desired optical state of the particular one of the pixels (18), and
supplying (10, 16) the drive waveforms (Dij) to the pixels (18).
